(19) United States
(12) Patent Application Publication
(10) Pub. No.: US 2026/0244447 A1
(43) Pub. Date: Aug. 20, 2026

(54) FETCH QUEUE POPULATION

(71) Applicant: Arm Limited, Cambridge (GB)

(72) Inventors: Houdhaifa BOUZGUARROU, Valbonne (FR); Michael Brian SCHINZLER, Round Rock, TX (US); Sergio SCHULER, Austin, TX (US); Jason Lee SETTER, Austin, TX (US)

(21) Appl. No.: 19/053,672

(22) Filed: Feb. 14, 2025

(51) Int. Cl. G06F 9/38; G06F 9/30

(52) U.S. Cl. CPC G06F 9/3804; G06F 9/3844; G06F 9/3848; G06F 9/3861

(57) ABSTRACT

There is provided an apparatus comprising a fetch queue to identify instructions to be fetched for execution, and entry storage to store prediction entries comprising a multi-taken entry identifying: a first branch instruction configured to divert control flow to a first target address identifying a second instruction block, and a second branch instruction comprised in the second instruction block and configured to divert control flow to a second target address. The apparatus comprises control circuitry responsive to a prediction identifying an outcome of both of the first and second branch instructions, to populate the fetch queue based on the prediction, and in response to a subsequent identification of a change in an outcome of the second branch instruction, to flush instruction addresses subsequent to a second branch instruction address and to retain instruction addresses up to and including the second branch instruction address in the fetch queue.

### TECHNICAL FIELD

The present invention relates to data processing. More particularly the present invention relates to an apparatus, a system, a chip-containing product, a method, and a computer-readable medium.

### BACKGROUND

Some apparatuses are provided with a fetch queue to identify instructions to be fetched for execution. The fetch queue may be populated based on a predicted outcome of a branch instruction.

### SUMMARY

According to a first aspect of the present techniques there is provided an apparatus comprising:
a fetch queue configured to identify a sequence of instructions to be fetched for execution;
prediction entry storage configured to store a plurality of prediction entries comprising a multi-taken entry, the multi-taken entry identifying:
   a first branch instruction comprised in a first instruction block and configured to divert control flow to a first target address identifying a second instruction block; and
   a second branch instruction comprised in the second instruction block and configured to divert control flow to a second target address; and
control circuitry responsive to a prediction associated with the multi-taken entry and identifying an outcome of both of the first branch instruction and the second branch instruction in which the first branch instruction is predicted to be taken,
   to populate the fetch queue based on the prediction; and
   in response to a subsequent identification of a change in an outcome of the second branch instruction, to flush instruction addresses subsequent to a second branch instruction address of the second branch instruction and to retain instruction addresses up to and including the second branch instruction address in the fetch queue.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system according to the second aspect, wherein the system is assembled on a further board with at least one other product component.

According to a fourth aspect of the present techniques there is provided a method of operating an apparatus comprising a fetch queue configured to identify a sequence of instructions to be fetched for execution, the method comprising:
storing a plurality of prediction entries comprising a multi-taken entry, the multi-taken entry identifying:
   a first branch instruction comprised in a first instruction block and configured to divert control flow to a first target address identifying a second instruction block; and
   a second branch instruction comprised in the second instruction block and configured to divert control flow to a second target address; and
in response to a prediction associated with the multi-taken entry and identifying an outcome of both of the first branch instruction and the second branch instruction in which the first branch instruction is predicted to be taken,
   populating the fetch queue based on the prediction; and
   in response to a subsequent identification of a change in an outcome of the second branch instruction, flushing instruction addresses subsequent to a second branch instruction address of the second branch instruction and retaining instruction addresses up to and including the second branch instruction address in the fetch queue.

According to a fifth aspect of the present techniques there is provided a non-transitory computer-readable medium storing computer-readable code for fabrication of an apparatus comprising:
a fetch queue configured to identify a sequence of instructions to be fetched for execution;
prediction entry storage configured to store a plurality of prediction entries comprising a multi-taken entry, the multi-taken entry identifying:
   a first branch instruction comprised in a first instruction block and configured to divert control flow to a first target address identifying a second instruction block; and
   a second branch instruction comprised in the second instruction block and configured to divert control flow to a second target address; and
control circuitry responsive to a prediction associated with the multi-taken entry and identifying an outcome of both of the first branch instruction and the second branch instruction in which the first branch instruction is predicted to be taken,
to populate the fetch queue based on the prediction; and
in response to a subsequent identification of a change in an outcome of the second branch instruction, to flush instruction addresses subsequent to a second branch instruction address of the second branch instruction and to retain instruction addresses up to and including the second branch instruction address in the fetch queue.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates an example multi-taken sequence according to some configurations of the present techniques;

FIG. 4 schematically illustrates an example multi-taken sequence according to some configurations of the present techniques;

FIG. 5 schematically illustrates an apparatus according to some configurations of the present techniques;

FIG. 6 schematically illustrates an example multi-taken sequence according to some configurations of the present techniques;

FIG. 7a schematically illustrates an apparatus according to some configurations of the present techniques;

FIG. 7b schematically illustrates an apparatus according to some configurations of the present techniques;

FIG. 7c schematically illustrates an apparatus according to some configurations of the present techniques;

FIG. 8 schematically illustrates a sequence of steps according to some configurations of the present techniques; and

FIG. 9 schematically illustrates a system and a chip containing product according to some configurations of the present techniques.

### DESCRIPTION OF EXAMPLE CONFIGURATIONS

Before discussing the configurations with reference to the accompanying figures, the following description of configurations is provided.

According to some configurations of the present techniques there is provided an apparatus comprising a fetch queue configured to identify a sequence of instructions to be fetched for execution. The apparatus comprises prediction entry storage configured to store a plurality of prediction entries comprising a multi-taken entry. The multi-taken entry identifies a first branch instruction comprised in a first instruction block and configured to divert control flow to a first target address identifying a second instruction block, and a second branch instruction comprised in the second instruction block and configured to divert control flow to a second target address. The apparatus comprises control circuitry responsive to a prediction associated with the multi-taken entry and identifying an outcome of both of the first branch instruction and the second branch instruction in which the first branch instruction is predicted to be taken, to populate the fetch queue based on the prediction. The control circuitry is configured in response to subsequent identification of a change in an outcome of the second branch instruction, to flush instruction addresses subsequent to a second branch instruction address of the second branch instruction and to retain instruction addresses up to and including the second branch instruction address in the fetch queue.

Prediction of an outcome of control flow altering instructions (e.g., conditional branch instructions or unconditional branch instructions) can involve the following stages:
1. For a given program counter address X identifying a block of one or more instructions, predict an instruction address X1 identifying a first control flow altering instruction (e.g., a conditional branch instruction or a non-conditional branch instruction) in the given block of instructions;
2. Predict the direction for the control flow altering instruction located at address X1, i.e., predict whether the control flow altering instruction will be taken or not taken;
3. If the control flow changing instruction is predicted as taken, then predict the target address, PC=Y, of the predicted control flow changing instruction; and
4. Populate a fetch queue with instruction addresses based on the outcome of predictions 1 to 3 to include instructions, from the block of instructions identified by program counter address X, and update the program counter for the next prediction based on the outcome of the predictions.

Such a prediction cycle enables the fetch queue to be updated to incorporate instruction addresses from one block of instructions per cycle and may be triggered, for example, through an entry in prediction entry storage identifying a predicted outcome for a single branch instruction.

In the event that a misprediction occurs the apparatus may be provided with one or more mechanisms to correct the instruction addresses identified in the fetch queue, for example, by storing one or more additional instruction addresses and prediction data associated with instructions that, according to the prediction, are not incorporated in the fetch queue. In the event that the prediction is then determined to be incorrect, the instructions resulting from the incorrect prediction can be flushed from the fetch queue and the stored instruction addresses can be used to repopulate the fetch queue without having to rerun the prediction cycle for that block of instructions.

The prediction entry storage of the present invention is configured to support multi-taken entries. A multi-taken entry is configured to identify a first branch instruction comprised in a first instruction block and a second branch instruction comprised in a second instruction block with the second instruction block being the target of the first branch instruction. The multi-taken entry therefore enables a prediction to be made that identifies an outcome of a first branch instruction and a second branch instruction that are expected to occur during program execution and, where a multi-taken entry is identified in the prediction storage, and the first branch instruction is predicted to be taken, the control circuitry can populate the fetch queue based on the outcome of both of the first and second branch instructions, thereby increasing the rate at which the fetch queue can be populated.

In general, a multi-taken entry is stored for cases in which it is more likely that at least the first branch instruction will be taken than not-taken. However, this does not have to be the case and, for a given instance of a prediction being made based on a multi-taken entry, either the first branch instruction and/or the second branch instruction may be predicted as not-taken. In the event that the first branch instruction is predicted as not-taken any prediction made in relation to the second branch instruction may be discarded or stored for subsequent use in the event that the first branch instruction has been mispredicted, and the fetch queue may be populated based only on the first branch prediction (because, according to the prediction, control flow would not be diverted to the second branch instruction). However, when the first branch instruction is predicted as taken, the fetch queue is populated based on both of the first branch instruction and the second branch instruction. For example, the fetch queue may be populated with instructions from the first block of instructions up to and including the first branch instruction, and instructions from the second block of instructions. The instructions included in the fetch queue from the second block of instructions is dependent on the predicted outcome of the second branch instruction. Where the second branch instruction is predicted as taken, the fetch queue would be populated with instruction addresses from the second block up to and including the second branch instruction address but not including instruction addresses subsequent to the second branch instruction address. Where the second branch instruction is predicted as not-taken, the fetch queue would be populated with instruction addresses from the second block of instructions including at least some of any instructions that occur sequentially after the second branch instruction (e.g., instructions that occur after the second branch instruction but before any other branch instructions predicted to occur in the second block of instructions).

The inventors have recognised that, whilst the use of two-taken entries can help to increase the rate at which the fetch queue is populated and, hence, the overall rate of instruction throughput, there are additional difficulties when the second branch instruction is mispredicted. In particular, it may be theoretically possible to store alternative instruction addresses and prediction information relating to the non-predicted path which can be used to re-populate the fetch queue in response to a misprediction of the second branch instruction. However, this requires a number of additional structures to be provided to store instructions related to the direction that was not predicted including providing means for identification and predicting any additional branch instructions that may be present in such non-predicted paths. Alternatively, it would also it is possible to flush all instructions associated with the second block of instructions from the fetch queue and to make a new prediction relating to that block of instructions. However, this approach would result in the unnecessary eviction of instructions from the fetch queue (i.e., those instructions that occur before the second branch instruction). The control circuitry is therefore configured, in response to identification of a misprediction of the second branch instruction, to flush the instructions that occur subsequent to the second branch instruction from the fetch queue and to retain instruction addresses up to and including the second branch instruction address in the fetch queue. This approach allows instructions that have not been identified as mispredicted to be retained in the fetch queue whilst evicting instruction addresses that have been mispredicted. As a result, the overall population of the fetch queue is improved.

Once the mispredicted instruction addresses are flushed from the fetch queue the control circuitry may be configured to repopulated the fetch queue based on identification of the misprediction. For example, in some configurations the control circuitry is configured, to perform a decomposition of the second instruction block to generate an instruction sub-block comprising instructions of the second instruction block subsequent to the second branch instruction; and when the subsequent identification identifies that the outcome of the second branch instruction has changed from taken to not-taken, to trigger a new prediction based on the instruction sub-block. In other words, rather than storing prediction information associated with the non-predicted path, the control circuitry is arranged to respond to the misprediction by triggering a new prediction. However, rather than performing the new prediction based on the entire second instruction block, the new prediction is based on the instruction sub-block, i.e., the instructions of the second instruction block that occur sequentially after the second branch instruction. For example, the new prediction may comprise performing a lookup in the prediction entry storage and discarding any prediction entries for which the first branch instruction is configured to occur at an instruction address not included in the instruction sub-block. This approach enables the misprediction to be corrected using existing prediction mechanisms whilst retaining instructions up to and including the second branch instruction in the fetch queue.

Alternatively, or in addition, in some configurations the control circuitry is configured, when the subsequent identification identifies that the outcome of the second branch instruction has changed from not-taken to taken, to trigger a new prediction based on a block of instructions identified by the second target address. In such a configuration, the new prediction is based on identifying a prediction entry associated with the second target address in the prediction entry storage. The new prediction may be a normal prediction entry in which only one branch instruction is predicted or, dependent on the use case, may be a further multi-taken entry in which a further first branch instruction and a further second branch instruction are predicted.

The change in outcome may result from a non-speculative execution of an instruction which resolves the correct outcome of the branch. Alternatively, in some configurations the subsequent identification is a subsequent prediction and the change in outcome is a change in a predicted outcome. In some apparatuses multiple predictors may be provided to determine a predicted outcome of the branch instructions. A first predictor may be arranged to provide a quick prediction and a subsequent predictor may be arranged to provide a subsequent prediction using structures that take longer to compute the prediction, but that are expected to provide a more accurate prediction. In such configurations the fetch queue can be populated based on the first prediction potentially enabling instructions to be fetched sooner. The subsequent prediction can then be used to verify the first prediction and/or to identify that a misprediction has occurred. The multiple predictors may comprise two predictors at two different stages in the fetch pipeline with the subsequent prediction being provided by the second predictor. However, in some configurations three or more predictors may be provided with the change in outcome being any change in prediction between any two of the predictors. For example, the change in prediction may be identified between the first and second predictor with a third predictor (and potentially further predictors) agreeing with the second predictor. Alternatively, the first and second predictors may agree with the third predictor (and potentially further predictors) disagreeing. It will be readily apparent to the skilled person that, where three or more predictors are present, the prediction may change multiple times. Indeed, for N predictors providing predictions at a respective N fetch stages of a pipeline, the predicted outcome may change N-1 times with the mechanisms described herein being used to correct the fetch queue and update the next block to be predicted at each of the N-1 occurrences of a change in prediction.

In some configurations the subsequent prediction is performed using a higher accuracy predictor than the prediction. For example, the higher accuracy predictor may take into account a greater amount of prediction history than the prediction and or one or more additional metrics. Alternatively, the higher accuracy predictor may use additional information and structures not available to the first predictor.

Whilst it will be readily apparent that any type of branch prediction circuitry can be used, in some configurations the apparatus comprises further prediction circuitry configured to provide the subsequent prediction based on a global history of outcomes of branch instructions. For example, the global history may comprise a vector having elements indicating, for each of a plurality of previous predictions, an indication of whether those predictions were taken or not-taken.

In some configurations the further prediction circuitry is tagged geometric history length (TAGE) prediction circuitry configured to predict whether conditional branch instructions will be taken or not based on a plurality of TAGE tables tagged by a range of lengths of execution history. The TAGE prediction circuitry implements a form of branch direction predictor referred to as a TAGE branch predictor. The TAGE prediction circuitry may be provided as a branch direction predictor to predict whether conditional control flow changing instructions will be taken or not taken. The TAGE prediction circuitry comprises a plurality of TAGE tables, each tagged by an indication of the execution history leading to the control flow changing instruction, with those indications representing a different length of execution history for the different TAGE tables. In order to track in which of those tables a hit needs to be detected for a given control flow changing instruction for a prediction to be made on the basis of the information stored in the TAGE tables, the prediction circuitry maintains a TAGE class value. For control flow changing instructions that are expected to be predicted with a high degree of confidence, the TAGE class value will be small such that only a small number of the TAGE tables (corresponding to shorter execution history length) need to have a hit detected for a prediction. Conversely, control flow changing instructions for which the direction is less certain will have a higher TAGE class value indicating that a hit needs to be detected in more TAGE tables (and so execution history having a longer length needs to match) for the prediction to be made. In some configurations the execution history is a global execution history common to all branch instructions.

The prediction may be generated in anyway, however, in some configurations the apparatus is provided with prediction circuitry responsive to receipt of an instruction block identifier to perform a lookup in the prediction entry storage circuitry, wherein the prediction circuitry is responsive to a hit in the prediction entry storage circuitry to generate the prediction. For example, the instruction block identifier may define a region of address space comprising 2^{N} addresses, where N is an integer. The instruction blocks may be aligned to address boundaries such that the instruction block identifier for a block of instructions is equal to a first portion of an address of each instruction comprised in that instruction block. For example, the instruction block identifier may omit the least significant M bits of the address of each instruction. The prediction entry storage circuitry may store information identifying an N bit instruction block identifier and the M bits required to specify an address of a branch instruction, along with a N bit block identifier for the target address. For the multi-taken entry, the prediction entry storage circuitry may store information identifying an N bit instruction block identifier, the M bits required to specify an address of the first branch instruction, an N-bit block identifier for the second target address, and an M-bit offset to identify the address of the second branch instruction along with the second target address.

For cases in which the change in the outcome of the second branch instruction is a change from taken to not-taken, in some configurations the control circuitry is responsive to an identification that the second branch instruction is a final instruction of the second instruction block, to omit the decomposition. In other words, the control circuitry is configured to identify that, because the second branch instruction is the sequentially final instruction in the block of instructions, performing the decomposition as described above would result in a prediction being based on a block of instructions containing zero instructions.

Instead of performing the decomposition, the control circuitry is responsive to the identification that the second branch instruction is the final instruction of the second instruction block, when the subsequent identification identifies that the outcome of the second branch instruction has changed from taken to not-taken, to trigger a new prediction to be performed for a sequentially next instruction block subsequent to the second instruction block. Specifically, where the second branch instruction is the final instruction in the second block of instructions, the next instruction to be processed will either be contained in the second target block of instructions or in the block of instructions that is subsequent to the second block of instructions. In some use cases, these blocks of instructions may be the same block of instructions, for example, if the second branch instruction branches to some instruction other than the first instruction in the second block of instructions. However, in general these blocks of instructions may be different blocks of instructions.

In some configurations the apparatus comprises buffer circuitry to store, as alternative instruction addresses, instruction addresses from the first instruction block subsequent to the first branch instruction, wherein the control circuitry is responsive to the subsequent identification identifying a change in a first outcome of the first branch instruction: to flush instruction addresses subsequent to the first branch instruction from the fetch queue; and to identify the alternative instruction addresses in the fetch queue. The apparatus may respond differently to a misprediction of the first branch instruction and a misprediction of the second branch instruction. In particular, the apparatus may be provided with buffer circuitry to enable a response to a misprediction of the first branch instruction to be performed without having to repredict the behaviour of the first block of instructions. However, where the second branch instruction is mispredicted, the apparatus may perform a further prediction relating to at least some instructions from the second block of instructions.

In some configurations the control circuitry is responsive to the subsequent identification identifying a change in the first outcome, to trigger a new prediction to be performed for a sequentially next instruction block subsequent to the first instruction block. For example, where it is determined that there are no further branch instructions in the first block of instructions that occur subsequent to the first branch instruction, the next block of instructions that would be encountered during execution would be the block subsequent to the first instruction block. By triggering a next prediction based on the block subsequent to the first instruction block, it may be possible to more rapidly re-populate the fetch queue in response to the misprediction.

Particular configurations will now be described with reference to the figures.

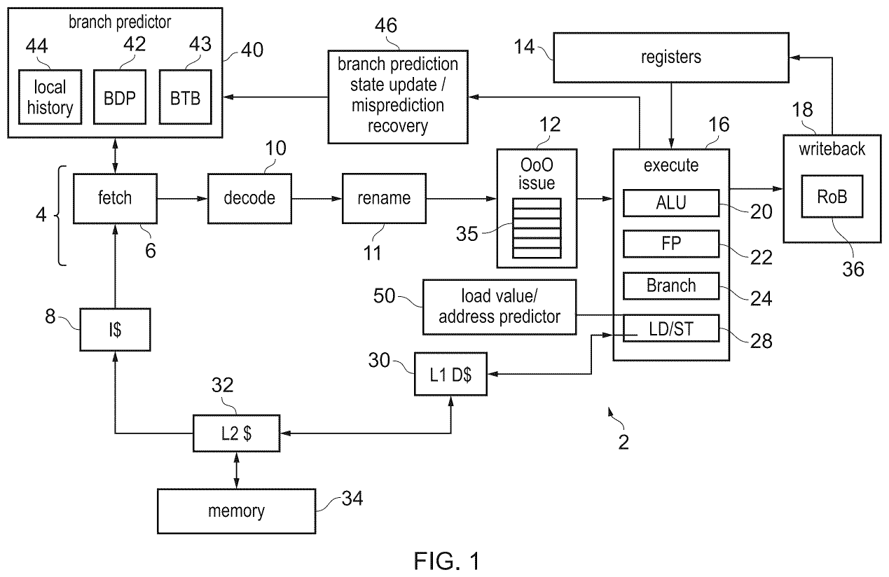

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations to be processed by remaining stages of the pipeline; a register renaming stage 11 for mapping architectural registers specified by program instructions or micro-operations to physical register specifiers identifying physical registers in a register file 14; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 28 for performing load/store operations to access data in a memory system 8, 30, 32, 34.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

The processor shown in FIG. 1 is an out-of-order processor where the pipeline 4 includes a number of features supporting out-of-order processing. This includes the issue stage 12 having an issue queue 35 for queuing instructions and issue control circuitry which is able to issue a given instruction for execution if its operands are ready, even if an earlier instruction in program order has not issued yet. Also the writeback stage 18 may include a reorder buffer (ROB) 36 which tracks the execution and the commitment of different instructions in the program order, so that a given instruction can be committed once any earlier instructions in program order have themselves be committed. Also, the register renaming stage 11 helps to support out of order processing by remapping architectural register specifiers specifying the instructions decoded by the decode stage 10 to physical register specifiers identifying physical registers 14 provided in hardware. The instruction encoding may only have space for a register specifiers of a certain limited number of bits which may restrict the number of architectural registers supported to a relatively low number such as 16 or 32. This may cause register pressure, where after a certain number of instructions have been processed a later instruction which independent of an earlier instruction which references a particular register needs to reuse that register for storing different data values. In an in-order processor, that later instruction would need to wait until the earlier reference to the same register has completed before it can proceed, but these register dependencies caused by insufficient number of architectural registers can be avoided in an out-of-order processor by remapping the references to the same destination register in different instructions to different physical registers within the register file 14, which may comprise a greater number of physical registers than the number of architectural registers supported in the instruction encoding. This can allow a later instruction which writes to a particular architectural register to be executed while an earlier instruction which writes to the same architectural register is stalled, because those register references are mapped to different physical registers in the register file 14. It will be appreciated that other features may support out of order processing.

As shown in FIG. 1, the apparatus 2 has a number of prediction mechanisms for predicting instruction behaviour for instructions at particular instruction addresses. For example, these prediction mechanisms may include a branch predictor 40 and a load value or load address predictor 50. It is not essential for processors to have both forms of predictor. The load value or load address predictor is provided for predicting data values to be loaded in response to load instructions executed by the load/store unit 28 and/or predicting load addresses from which the data values are to be loaded before the operands for calculating the load addresses have been determined. For example, the load value prediction may record previously seen values loaded from a particular address, and may predict that on subsequent instances of loading from that address the value is expected to be the same. Also, the load address predictor may track history information which records observed stride patterns of address accesses (where the addresses of successive loads differ by a constant offset) and then use that observed stride pattern to predict the address of a future load instructions by continuing to add offsets to the latest seen address at intervals of the detected stride.

Also, the branch predictor 40 may be provided for predicting outcomes of branch instructions (otherwise referred to as control flow altering instructions), which are instructions that can cause a non-sequential change of program flow. Branches may be performed conditionally, so that they may not always be taken. The branch predictor is looked up based on addresses of instructions provided by the fetch stage 6, and provides a prediction of whether those instruction addresses are predicted to correspond to branch instructions. For any predicted branch instructions, the branch predictor provides a prediction of their branch properties such as a branch type, branch target address and branch direction (branch direction is also known as predicted branch outcome, and indicates whether the branch is predicted to be taken or not taken). The branch predictor 40 includes a branch target buffer (BTB) 43 for predicting properties of the branches other than branch direction, and a branch direction predictor (BDP) 42 for predicting the not taken/taken outcome of a branch (branch direction). It will be appreciated that the branch predictor could also include other prediction structures, such as a call-return stack for predicting return addresses for function calls, a loop direction predictor for predicting when a loop controlling instruction will terminate a loop, or other specialised types of branch prediction structures for predicting behaviour of branches in specific scenarios. In general, the BTB may act as a cache correlating particular instruction addresses with sets of one or more branch properties such as branch type or the branch target address (the address predicted to be executed next after the branch if the branch is taken), and may also provide a prediction of whether a given instruction address is expected to correspond to a branch at all.

The branch direction predictor 42 may be based on a variety of different prediction techniques, e.g. a TAGE predictor or a perceptron predictor, which includes prediction tables which track prediction state used to determine whether, if a given instruction address is expected to correspond to a block of instructions including a branch, whether that branch is predicted to be taken or not taken. The BDP 42 may base its prediction on local history records tracked in local history storage circuitry 44. The local history records will be discussed in more detail below, but in general they provide tracking of sequences of observed instruction behaviour for instructions whose instruction addresses map onto a particular subset of instruction addresses, with a number of separate local history records being provided for different subsets of instruction addresses. This can be used for indexing into the prediction tables of the BDP 42 or in some cases to provide a direct prediction of the predicted branch behaviour.

The apparatus 2 may have branch prediction state updating circuitry and misprediction recovery circuitry 46, which updates state information within the branch predictor 40 based on observed instruction behaviour seen at the execute stage 16 for branch instructions executed by the branch unit 24. When a branch instruction is executed and the observed behaviour for the branch matches the prediction made by the branch predictor 40 (both in terms of whether the branch is taken or not and in terms of other properties such as branch target address) then the branch prediction state updating circuitry 46 may update prediction state within the BDP 42 or the BTB 43 to reinforce the prediction that was made so as to make it more confident in that prediction when that address is seen again later. Alternatively, if there was no previous prediction state information available for a given branch then when that branch is executed at the execute stage 16, its actual outcome is used to update the prediction state information. Similarly, the local history storage 44 may be updated based on an observed branch outcome for a given branch.

On the other hand, if a misprediction is identified when the actual branch outcome 24 differs from the predicted branch outcome in some respect, then the misprediction recovery portion of the state updating/misprediction recovery circuitry 46 may control updating of state within the branch predictor 40 to correct the prediction state so that it is more likely that the prediction will be correct in future. In some cases, a confidence counter based mechanism may be used so that one incorrect prediction does not necessarily overwrite the prediction state which has previously been used to generate a series of correct predictions, but multiple mispredictions for a given instruction address will eventually cause the prediction state to be updated so that the outcome actually being seen at the execute stage 60 is predicted in future. As well as updating the state information within the branch predictor 40, on a misprediction, the misprediction recovery circuitry may also cause instructions to be flushed from the pipeline 4 which are associated with instruction addresses beyond the address for which the misprediction was identified, and cause the fetch stage 6 to start refetching instructions from the point of the misprediction.

As discussed above, the apparatus 2 may be provided with plural prediction circuits providing predictions for a given block of instructions at different stages in the fetch circuitry 6. The predictions provided at different stages of the fetch circuitry may increase in complexity and accuracy so that an early prediction can be provided at an early stage in the fetch circuitry with that early prediction being either confirmed or overwritten once a more accurate prediction is available. The early prediction therefore allows the fetch queue to be populated sooner with the more accurate prediction mechanisms being provided to correct an ideally small number of cases for which the early predictor is inaccurate. Further details on the mechanisms for correcting cases in which the predictors disagree are described below.

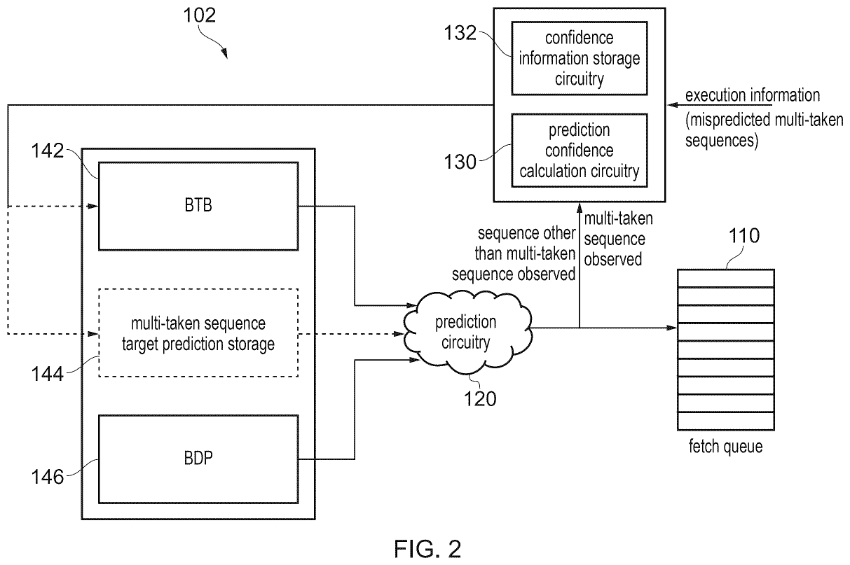

FIG. 2 is a schematic illustrating further detail of an apparatus 102 in accordance with some configurations of the present techniques. The apparatus 102 implements branch prediction to populate a fetch queue 110 (also referred to as a prediction address queue) with instruction addresses that identify instructions to be fetched for execution by one or more execution units of the apparatus 102. Those addresses can be routed to an instruction cache (not shown) that retrieves the instructions at the identified addresses (if a hit is detected in the instruction cache for an input address, then the instruction can be output directly from the instruction cache, whereas otherwise the instruction can be requested from a lower level of a memory hierarchy forming the memory system and, when retrieved, can be output from the instruction cache). The fetched instructions are then forwarded to an instruction decoder where they are decoded in order to produce control signals used to control the operation of the execution units so as to implement the operations required by those instructions.

The apparatus 102 may be arranged during each prediction iteration to consider a predict block of instructions, where the predict block comprises a plurality of sequential instructions within the memory address space. The predict block may for example be identified by a start address identifying the first instruction address within the predict block, and the size of the predict block will typically be predetermined. For example, a 32 byte predict block may be considered in each prediction iteration, and in one particular implementation each instruction may have an instruction address formed of 4 bytes, such that each predict block represents eight instructions at sequential addresses in memory.

Each predict block predicted by the apparatus 102 is added into the fetch queue 110, whilst also being provided to various branch prediction mechanisms within the apparatus 102. The aim of the apparatus 102 is to predict whether any instructions identified by the predict block are control flow changing instructions that are predicted as taken. In the event that the predict block includes one or more of such instructions, then the location of the first control flow changing instruction that is predicted as taken is identified, and the target address of that control flow changing instruction is used to identify the start address for the next predict block. If no such control flow changing instructions are identified within the predict block, then the start address for the next predict block is merely the sequential address following the last address of the current predict block. When the branch predictor 110 predicts that a predict block does include a control flow changing instruction that is predicted as taken, then the position of that control flow changing instruction is used to modify the content of the predict block as added into the fetch queue 110. For example, if it is determined that the fourth instruction in the sequence of eight identified by a predict block is predicted as taken, then the final four instructions will be discarded from the sequence of instructions identified within the fetch queue 110, so that those later instructions are not fetched for execution by the execution circuitry, and instead the next instruction fetched after the fourth instruction in that predict block will be the instruction at the predicted target address for the control flow changing instruction (i.e. the first instruction in the next predict block).

The apparatus 102 can include a number of branch prediction components. As shown in FIG. 2, a branch direction predictor (BDP) 146 can be used for seeking to predict whether a conditional control flow changing instruction will be taken or not taken. If a control flow changing instruction is not taken, then the next instruction to be executed will be the instruction immediately following that instruction flow changing instruction in the instruction address space. However, if the instruction flow changing instruction is predicted as taken, then a determination of the target address for that instruction is required, as the next instruction that will be predicted to be executed will be the instruction at that target address.

To assist in the prediction of target addresses, one or more branch target buffer (BTB) structures may be provided. For example, as illustrated in FIG. 2, a BTB 142 is provided for making a prediction of the target address of a control flow changing instruction that is predicted as taken. Hence, for a control flow changing instruction that is predicted as taken, the BTB 142 can be used to assist in the determination of a target address for that control flow changing instruction. In particular, an entry may be provided for that control flow changing instruction, and may include information that is used to determine a predicted target address. That predicted target address may be encoded directly within the entry of the BTB, or alternatively a further target prediction structure may be referenced in order to predict the target address. For example, if the BTB 142 identifies that the branch instruction is a function return instruction, then the target address itself may not be identified within the BTB entry, but instead a return stack structure will be referred to in order to obtain the predicted target address.

The throughput of the apparatus 102 can effectively represent a bottleneck within the system. In particular, the fetch queue 110 may be able to receive multiple blocks of instructions in a single cycle, but the apparatus 102 itself may only be able to receive and process a single block of instructions in one cycle. In accordance with the techniques described herein, a mechanism is provided that enables multi-taken sequences to be populated in target prediction storage (either the BTB 142 or separately provided multi-taken sequence target prediction storage 144) to enable two blocks of instructions to be added into the fetch queue 110 in a single cycle.

To support this behaviour and so as to maintain the accuracy of prediction, prediction confidence calculation circuitry 130 is provided to monitor confidence levels associated with a plurality of multi-taken sequences in order to control which multi-taken sequences predictions should be allowed to be made.

In accordance with the techniques described herein, the prediction confidence calculation circuitry 130 maintains confidence information stored in confidence information storage circuitry 132 to identify multi-taken sequences and maintain an associated confidence level associated with such sequences. Based on execution information from execution circuitry (which may include instances of misprediction where a multi-taken sequence was incorrectly predicted, and observed sequences of instructions where multi-taken sequences are either taken or not taken), the prediction confidence calculation circuitry 130 updates the confidence information in the confidence information storage circuitry 132 to represent any resulting changes in the confidence levels.

Based on the confidence levels for the multi-taken sequences, the prediction confidence circuitry populates and invalidates entries in the target prediction storage for multi-taken sequences (which may be implemented as dedicated multi-taken sequence target prediction storage 144 or may be implemented as part of the BTB 142).

Prediction circuitry 120 is provided to make determinations, based on the prediction components (including the BTB 142, the multi-taken sequence target prediction storage 144 if provided, and the branch direction predictor 146) about which predictions should be made and so how to populate the fetch queue 110. Hence, by altering which indications of multi-taken sequences are stored in the target prediction storage 142, 144, the prediction confidence calculation circuitry is able to control whether the prediction circuitry 120 is allowed to predict particular multi-taken sequences.

In this way, the prediction confidence calculation circuitry 130 is able to allow the prediction circuitry 120 to make predictions of multi-taken sequences, even when it is not known for certain whether the multi-taken sequence will turn out to be executed as predicted, whilst maintaining a high level of accuracy so as to reduce the incidence of mispredictions.

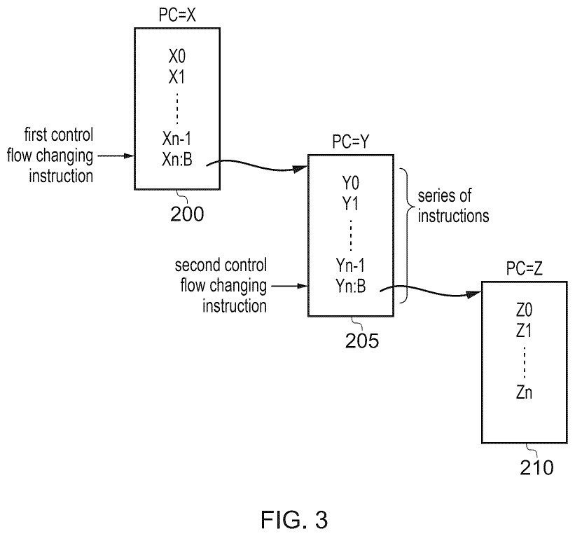

FIG. 3 schematically illustrates an example multi-taken sequence of the form that may be predicted using the apparatus 102 of FIG. 2. In this instance, a first predict block X 200 is assumed to contain a control flow changing instruction, having address Xn, that is predicted as taken and that results in the identification of a target address identifying the next predict block Y 205. This second predict block Y terminates with a control flow changing instruction that branches to the predict block Z 210. In such situations, it has been found possible to create an entry within target prediction circuitry 142, 144 that identifies as a first control flow changing instruction the branch instruction within the predict block X 200, along with an indication of the associated target address Y0, and in addition captures sufficient information about the predict block Y 205 and the resulting target address ZO to enable both the predict blocks Y 205 and Z 210 to be added directly into the fetch queue, but with the next prediction iteration starting with the predict block Z 210.

Control flow changing instructions can be categorised into two types, namely those exhibiting dynamic behaviour and those exhibiting static behaviour. Dynamic behaviour instructions change their behaviour dependent on the status of the processor executing those instructions. Hence, dynamic control flow changing instructions include any form of conditional branch instruction, since a direction prediction is required in order to determine whether the branch will be taken or not taken, and typically an assessment of certain condition flags of the processor is required in order to determine whether the control flow changing instruction will be taken or not. As another example of a dynamic behaviour branch instruction, polymorphic indirect branches will also be considered to exhibit dynamic behaviour, since typically the target address will depend on the contents of at least one general purpose register, and those contents will vary between instances where that indirect branch instruction is executed.

Static behaviour branch instructions are then the remaining branch types. Hence, any unconditional direct control flow changing instruction will be considered to exhibit static behaviour, since it will always be taken, and the target address can be determined directly from the branch instruction itself, and hence does not vary each time the unconditional direct branch instruction is executed. Also, for the purposes of the techniques described herein, unconditional function return instructions can be considered to exhibit static behaviour since, despite the fact that the target address can vary (for example due to different function call instructions being associated with the same function return instruction), the target address is predictable in that it can be obtained from a return stack structure.

In some configurations, multi-taken sequences exhibiting static behaviour, (i.e., for which the second control flow changing instruction has static behaviour and none of the series of instructions occurring earlier in the predict block Y 205 than the second control flow changing instruction Yn are control flow changing instructions) are predicted. This may be done to ensure accuracy of prediction since if the first control flow changing instruction is correctly predicted (e.g., using existing prediction structures) it will be known that the multi-taken sequence will proceed as predicted.

In addition, in some configurations, as well as predicting multi-taken sequences that exhibit static behaviour, multi-taken sequences that exhibit dynamic behaviour can be predicted. Thus, multi-taken sequences having as their second control flow changing instruction a conditional control flow changing instruction and multi-taken sequences having additional control flow changing instructions in the series of instructions can be predicted. This can therefore increase the rate at which predictions can be made, with the prediction confidence calculation circuitry 130 operating to ensure that a desired level of prediction accuracy is maintained.

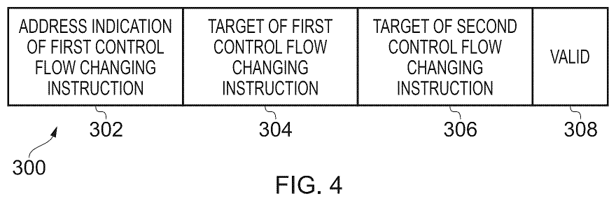

FIG. 4 illustrates a target prediction entry 300 used to store an indication of a multi-taken sequence for reference by the prediction circuitry 120. As illustrated, the entry comprises an address indication of a first control flow changing instruction to identify the address of either a first control flow changing instruction or a predict block containing such a first control flow changing instruction. The entry 300 also identifies a target of the first control flow changing instruction 304 and a target of the second control flow changing instruction 306. Based on this information, the prediction circuitry 120 can cause the predict blocks containing the targets of the first and second control flow changing instructions respectively to be identified in the fetch queue 110. The target prediction entry 300 also comprises a valid indicator 308 to indicate whether the target prediction entry 300 is a valid entry upon which a prediction can be based. This may be implemented as a single bit having a first value (e.g., zero) to indicate that the entry is valid and can be used by the prediction circuitry 20 to make predictions and a second value (e.g., one) to indicate that the entry is invalid and so should not be used as the basis of predictions. Thus, to prevent the multi-taken sequence being predicted by the prediction circuitry 120, the prediction confidence calculation circuitry 130 can set the valid indicator to the second value, thereby preventing the multi-taken sequence associated with the entry 300 being predicted.

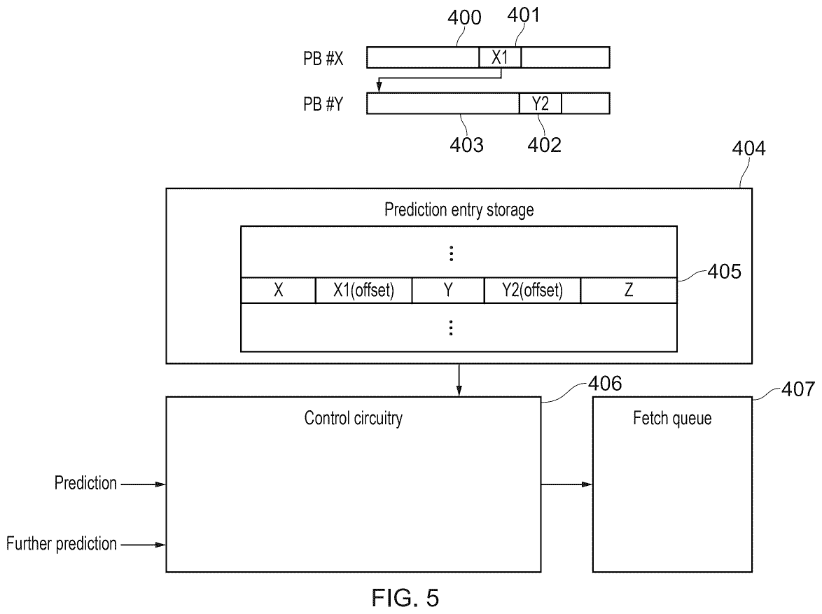

FIG. 5 schematically illustrates further details of an apparatus according to some configurations of the present techniques. The apparatus is provided with prediction entry storage 404, control circuitry 406 and a fetch queue 407. The fetch queue 407 is provided to store a sequence of instruction addresses identifying a sequence of instructions to be fetched for execution. The fetch queue 407 is populated by control circuitry 406 which may be comprised within a fetch unit.

The prediction entry storage 404 is configured to store prediction entries and may be arranged as the multi-taken sequence target prediction storage 144 described in relation to FIG. 2. The prediction entries include a multi-taken entry 405 identifying a first instruction block 400 having address X, an offset of a first branch instruction X1 401 comprised in the first block of instructions, a first target address Y 403 identifying a second instruction block, an offset of a second branch instruction Y2 402 comprised in the second block of instructions, and a second branch target Z identifying a further block of instructions.

The control circuitry 406 is responsive to receipt of a prediction to populate the fetch queue based on that prediction. The control circuitry 406 is configured, to receive a prediction and a further prediction. The prediction is an early prediction received, for a given branch instruction at an early stage in the prediction pipeline. Such a prediction may use a relatively simple prediction structure, for example, based on a saturating counter tracking whether an instance of a branch is strongly not taken, not taken, taken, or strongly taken, to generate an initial indication of whether a given branch is taken or not-taken. The further prediction is received for the same branch in a later cycle than the one in which the prediction is received. Where the prediction and the further prediction are in agreement, no action is taken by the control circuitry 406 to modify the entries in the fetch queue 407. However, in the event that the further prediction disagrees with the prediction, the control circuitry 406 triggers a change in the sequence of instruction addresses indicated in the fetch queue. This may result in a delay in the fetching of the instructions, but reduces a likelihood of a misprediction being subsequently identified (i.e., when the true outcome of the branch instruction is resolved during execution), which could result in instructions being flushed from further down the pipeline.

In response to receipt of a program counter value indicating a first block of instructions X 400, the control circuitry 406 receives an indication of the multi-taken entry 405 and prediction information relating to that program counter value. Where the prediction indicates that the first branch instruction 401 is taken, the control circuitry 406 causes the fetch queue 407 to be populated based on the multi-taken sequence. For example, where the prediction indicates that both the first branch instruction 401 and the second branch instruction 402 are taken, the control circuitry 406 triggers the fetch queue to be populated with instruction addresses from the first block of instructions 400 up to and including the first branch instruction 401, and instruction addresses from the second block of instructions 403 up to and including the second branch instruction 402. The control circuitry 406 then triggers the program counter to update so that the next block of instructions indicated is block of instructions Z. On the other hand, where the prediction indicates that the first branch instruction 401 is taken and the second branch instruction 402 is not taken, the control circuitry 406 triggers the fetch queue to be populated with instruction addresses from the first block of instructions 400 up to and including the first branch instruction 401, and instruction addresses from the second block of instructions 403. The control circuitry 406 then triggers the program counter to update so that the next block of instructions indicated is the block of instructions that sequentially follows the second block of instructions 403.

The control circuitry 406 is responsive to receipt of the further prediction, in relation to the program counter value indicating the first block of instructions X, the further prediction received subsequent to the prediction, to determine whether the further prediction indicates a change in the outcome of the second branch instruction 402. In the event that the further prediction indicates a change in the outcome, the control circuitry 406 triggers a flush of instruction addresses subsequent to an address of the second branch instruction 402 from the fetch queue 407 and retains instruction addresses up to and including the address of the second branch instruction in the fetch queue 407. Where the further prediction indicates that the predicted outcome of the second branch instruction 402 has changed from taken to not-taken, the control circuitry 406 triggers the program counter value to update so that the next block of instructions indicated is a sub-block of instructions comprising the instructions subsequent to the second branch instruction 402 in the second block of instructions 403. Alternatively, where the further prediction indicates that the predicted outcome of the second branch instruction 402 has changed from not-taken to taken, the control circuitry 406 then triggers the program counter to update so that the next block of instructions indicated is block of instructions Z.

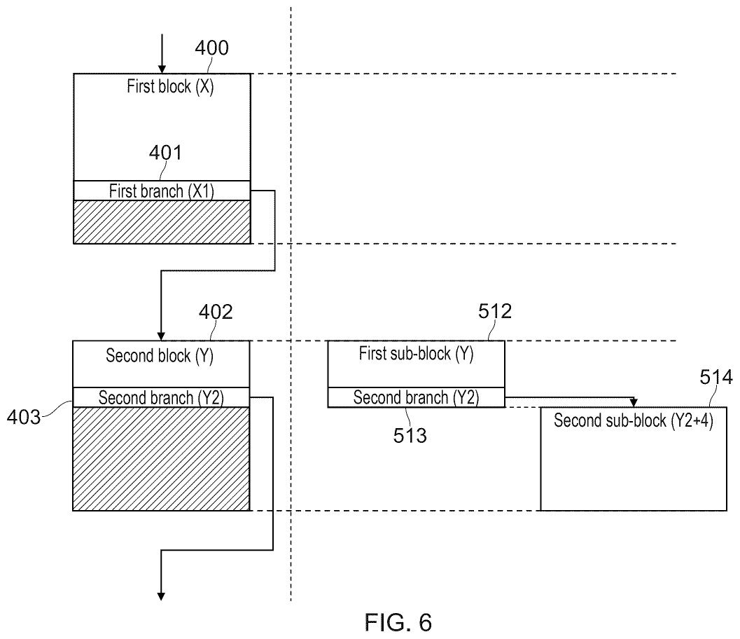

FIG. 6 schematically illustrates the effect of the further prediction resulting in the predicted outcome of the second branch instruction 403 changing from taken to not-taken. The left hand side of FIG. 6 schematically illustrates the program flow from the program counter identifying an address X of the first block of instructions 400. A lookup is performed in the prediction entry storage 404 and the multi-taken entry 405 is identified. The multi-taken entry 405 combined with an initial prediction that both the first branch instruction 401 and the second branch instruction 402 will be taken identifies the control flow indicated on the left hand side of FIG. 6. Regions of the first block of instructions 400 and the second block of instructions 402 shaded with diagonal lines indicate instruction addresses that are not passed to the fetch queue 407. In particular, on receipt of program counter X, the prediction that both branch instructions are taken indicates that the fetch queue will be populated with instruction addresses beginning at address X and including up to instruction address X1 of the first branch instruction 401. The fetch queue will then sequentially contain the instruction addresses indicated in the second block of instructions 402 beginning at address Y and continuing up to and including instruction address Y2. Subsequently, the fetch queue will be populated based on the target address Z indicated in the multi-taken entry.

When the further prediction indicating that the predicted outcome of the second branch instruction has changed is received and the control circuitry 406 triggers any instructions subsequent to the second branch instruction 403 to be flushed from the fetch queue. This includes any instructions beginning at instruction address Z incorporated into the fetch queue subsequent to instruction address Y2. The control circuitry 406 causes the fetch queue to be repopulated by triggering the next prediction to be made based on instructions incorporated in the second block of instructions 402 that occur subsequent to the second branch instruction. Schematically, this is illustrated on the right hand side of FIG. 6 in which the second block of instructions 402 is decomposed into two sub-blocks of instructions. The two sub-blocks of instructions comprising the first sub-block of instructions 512 and the second sub-block of instructions 514. The first sub-block of instructions 512 includes instructions from the second block of instructions 402 starting at instruction address Y and including consecutive instructions from the second block of instructions up to and including the address Y2 of the second branch instruction. The second sub-block of instructions 514 includes instructions from the second block of instructions 402 beginning at address Y2+4, i.e., the address of the sequentially next instruction subsequent to the second branch instruction 513 and includes consecutive instructions to the end of the second block of instructions. The second sub-block of instructions 514 is then considered as a block of instructions to be predicted including a lookup in the prediction entry storage to identify whether there are any further branch instructions present in the second sub-block of instructions and any branch direction predictions associated with a predicted branch instruction.

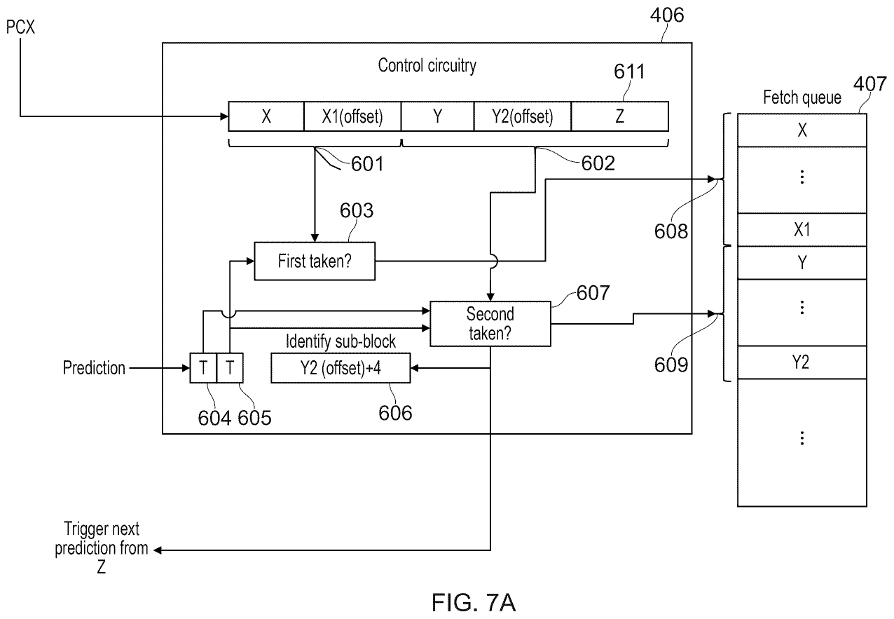

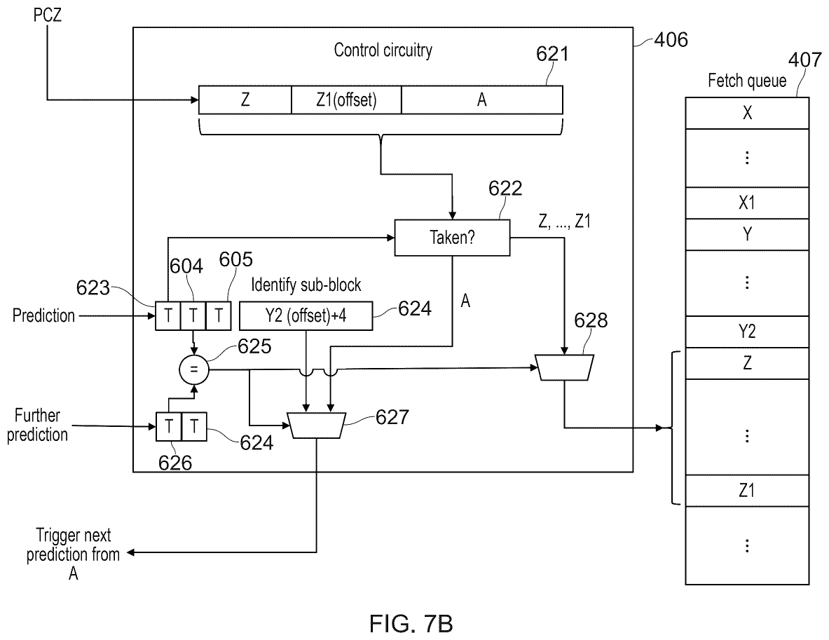

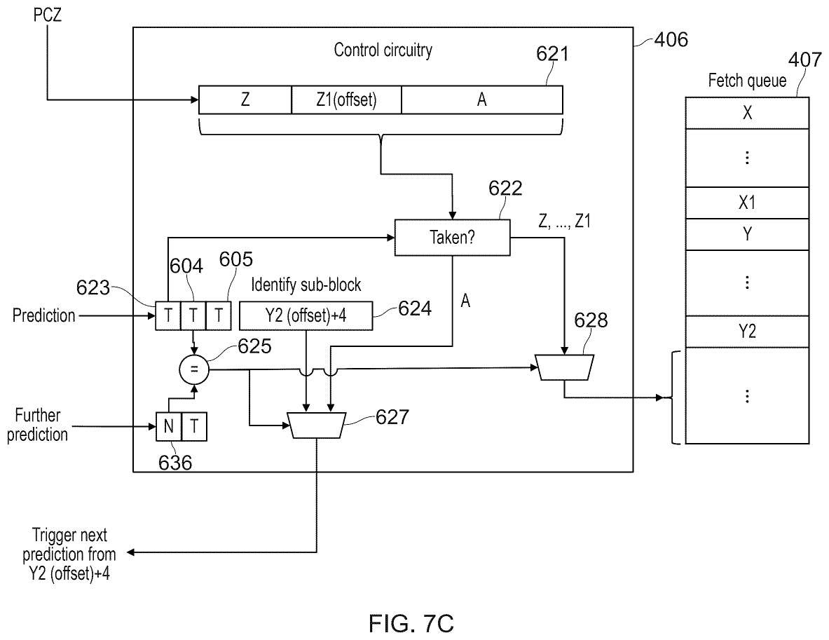

FIGS. 7A to 7C schematically illustrate details of the control circuitry 406 and the fetch queue 407 in response to a sequence of predictions. In FIG. 7A, the control circuitry 406 receives an indication of a prediction associated with a multi-taken entry 611. The multi-taken entry 611 identifies a first block of instructions at address X, a first branch instruction at address X1, a second block of instructions at address Y (the target address of the first branch instruction), a second branch instruction at address Y2, and a target address Z of the second branch instruction. The control circuitry 406 also receives a prediction, in this case, the prediction includes a first prediction 605 indicating that the first branch instruction is predicted to be taken (T), and a second prediction 604 indicating that the second branch instruction is predicted to be taken (T). The first prediction 605 is provided to a first address population circuit 603 which identifies that the first branch instruction is predicted taken. In addition, details of the instruction addresses 601 of the first block of instructions are passed to the first address population circuit 603 which, because the first branch is predicted taken, populates the fetch queue 407 with the instruction addresses 608 from X to X1. The first prediction 605 and the second prediction 604 are both provided to a second address population circuit 607 which identifies that both the first and second branch instruction are predicted as taken. In addition, details of the instruction addresses 602 of the second block of instructions are passed to the second address population circuit 607 which, because both the first and second branches are predicted as taken, populates the fetch queue 407 with the instruction addresses 609 from Y to Y2. The control circuitry 406 outputs an indication that the next prediction should be made from instruction address Z.

FIG. 7B schematically illustrates a next cycle in which the control circuitry 406 receives a prediction associated with instruction address Z. In this case, the received prediction 621 is a single taken entry indicating a branch instruction at address Z1 with a target address A. The control circuitry receives a further prediction 623 associated with the prediction entry 621. In the illustrated configuration, this branch is also predicted as taken. The further prediction 623 is passed to address population circuitry 622 which, because the further prediction indicates taken, selects instructions from Z to Z1 (Z, . . . , Z1) and forwards them to switch circuitry 628 to be populated into the fetch queue 407. The control circuitry 406 also receives a further prediction in relation to the multi-taken entry 611 that was predicted in the preceding cycle. The further prediction is received from a more accurate prediction circuit and, in the illustrated configuration, predicts that the first branch instruction of the multi-taken entry is predicted taken 624 and the second branch instruction of the multi-taken entry 611 is predicted taken 626. The control circuitry comprises comparison circuitry 625 to compare the prediction for the second branch instruction 604 and the further prediction for the second branch instruction 626 against one another. Because the comparison circuitry 625 identifies that the prediction 604 and the further prediction 626 are equal to one another, the comparison circuitry 625 triggers the switch circuitry 628 to forward the instruction addresses to the fetch queue 407. In addition, the comparison circuitry 625 triggers switch circuitry 627 to select the next prediction address based on the confirmation that the branch instruction is correct. In the illustrated configuration the next prediction occurs from address A, the target address of the single taken entry 621.

FIG. 7C schematically illustrates an alternative next cycle that may occur in place of the cycle illustrated in FIG. 7B. In particular, in the illustrated cycle, the further prediction for the second branch instruction 636 of the multi-taken entry differs from the prediction for the second branch instruction 604 for the multi-taken entry. Because the prediction 604 and the further prediction 636 are not equal to one another, the comparison circuitry 625 prevents the instruction addresses from Z to Z1 (Z, . . . , Z1) being forwarded to the fetch queue. Furthermore, the comparison circuitry 625 triggers the control circuitry 406 to identify the sub-block beginning at Y2+4 as the next prediction.

It will be readily apparent to the skilled person that the control circuitry may also perform corrective measures in the event that the prediction for the first branch instruction and the further first prediction disagree with one another including modifying the instructions identified in the fetch queue and triggering a repopulation based on the alternative prediction as described above. Furthermore, whilst two predictions are illustrated, the prediction and the further prediction, it will be readily apparent that some apparatuses may be provided with three or more predictors with predictions being made at a variety of different stages within the fetch circuitry. The initial prediction may therefore be confirmed by a second prediction at a second fetch stage and then, subsequently, be corrected by a third or fourth prediction. It will be readily apparent that the later the stage at which the prediction is corrected, the greater the number of instruction addresses that may have been identified in the fetch queue. Hence, where a late prediction is received, a greater number of instruction addresses would need to be flushed from the fetch queue as described above.

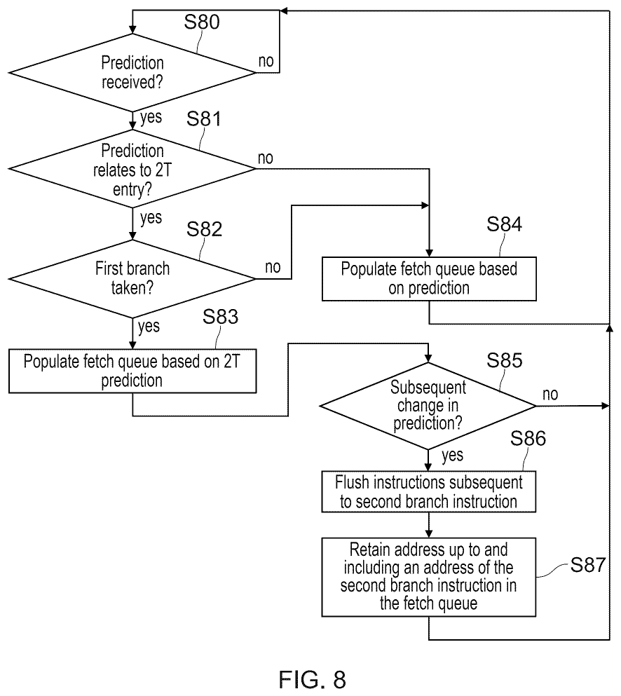

FIG. 8 schematically illustrates a sequence of steps carried out according to some configurations of the present techniques. Flow begins at step S80 where it is determined if a prediction has been received. If, at step S80, it is determined that no predictions have been received, then flow remains at step S80. If, at step S80, it is determined that a prediction has been received, then flow proceeds to step S81 where it is determined if the prediction relates to a multi-taken (2T) entry. If, at step S81, it is determined that the prediction does not relate to a multi-taken entry, then flow proceeds to step S84 where the fetch queue is populated based on the prediction before flow returns to step S80. If, at step S81, it is determined that the prediction relates to a multi-taken entry, then flow proceeds to step S82 where it is determined if the first branch is predicted taken. If, at step S82, it is predicted that the first branch is not taken, then flow proceeds to step S84 where the fetch queue is populated based on the prediction before flow returns to step S80. If, at step S82, it is determined that the first branch is predicted taken, then flow proceeds to step S83 where the fetch queue is populated based on the multi-taken entry. Flow then proceeds to step S85 where it is determined if a subsequent change in the prediction has been received. If, at step S85, it is determined that no subsequent change in prediction is received, then flow returns to step S80. If, at step S85, it is determined that a subsequent change in the prediction has been received, then flow proceeds to step S86. At step S86 instructions subsequent to the second branch instruction are flushed from the fetch queue. Flow then proceeds to step S87 where instructions up to and including the address of the second branch instruction are retained in the fetch queue. Flow then returns to step S80 for a subsequent prediction to be performed.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

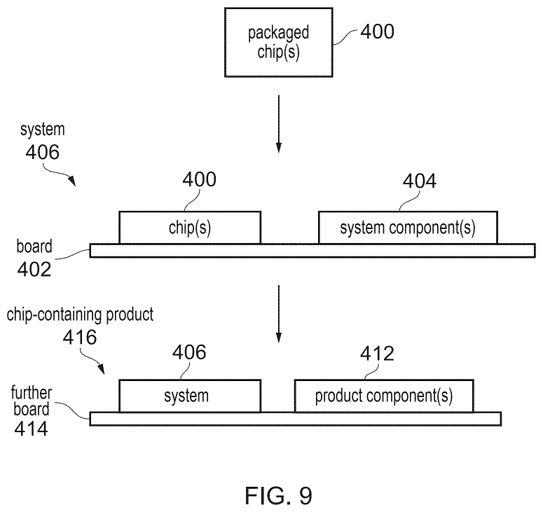

As shown in FIG. 9, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising a fetch queue to identify instructions to be fetched for execution, and entry storage to store prediction entries comprising a multi-taken entry identifying: a first branch instruction configured to divert control flow to a first target address identifying a second instruction block, and a second branch instruction comprised in the second instruction block and configured to divert control flow to a second target address. The apparatus comprises control circuitry responsive to a prediction identifying an outcome of both of the first and second branch instructions, to populate the fetch queue based on the prediction, and in response to a subsequent identification of a change in an outcome of the second branch instruction, to flush instruction addresses subsequent to a second branch instruction address and to retain instruction addresses up to and including the second branch instruction address in the fetch queue.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:
Clause 1. An apparatus comprising:
   a fetch queue configured to identify a sequence of instructions to be fetched for execution;
   prediction entry storage configured to store a plurality of prediction entries comprising a multi-taken entry, the multi-taken entry identifying:
      a first branch instruction comprised in a first instruction block and configured to divert control flow to a first target address identifying a second instruction block; and
      a second branch instruction comprised in the second instruction block and configured to divert control flow to a second target address; and
   control circuitry responsive to a prediction associated with the multi-taken entry and identifying an outcome of both of the first branch instruction and the second branch instruction in which the first branch instruction is predicted to be taken,
      to populate the fetch queue based on the prediction; and
      in response to a subsequent identification of a change in an outcome of the second branch instruction, to flush instruction addresses subsequent to a second branch instruction address of the second branch instruction and to retain instruction addresses up to and including the second branch instruction address in the fetch queue.
Clause 2. The apparatus of clause 1, wherein the control circuitry is configured,
   to perform a decomposition of the second instruction block to generate an instruction sub-block comprising instructions of the second instruction block subsequent to the second branch instruction; and
   when the subsequent identification identifies that the outcome of the second branch instruction has changed from taken to not-taken, to trigger a new prediction based on the instruction sub-block.
Clause 3. The apparatus of clause 1 or clause 2, wherein the control circuitry is configured, when the subsequent identification identifies that the outcome of the second branch instruction has changed from not-taken to taken, to trigger a new prediction based on a block of instructions identified by the second target address.
Clause 4. The apparatus of any preceding clause, wherein the subsequent identification is a subsequent prediction and the change in outcome is a change in a predicted outcome.
Clause 5. The apparatus of clause 4, wherein the subsequent prediction is performed using a higher accuracy predictor than the prediction.
Clause 6. The apparatus of clause 4 or clause 5, comprising further prediction circuitry configured to provide the subsequent prediction based on a global history of outcomes of branch instructions.
Clause 7. The apparatus of clause 6, wherein the further prediction circuitry is tagged geometric history length (TAGE) prediction circuitry configured to predict whether conditional branch instructions will be taken or not based on a plurality of TAGE tables tagged by a range of lengths of execution history.
Clause 8. The apparatus of clause 7, wherein the execution history is a global execution history common to all branch instructions.
Clause 9. The apparatus of any preceding clause, comprising prediction circuitry responsive to receipt of an instruction block identifier to perform a lookup in the prediction entry storage circuitry, wherein the prediction circuitry is responsive to a hit in the prediction entry storage circuitry to generate the prediction.
Clause 10. The apparatus of any preceding clause when dependent on clause 2, wherein the control circuitry is responsive to an identification that the second branch instruction is a final instruction of the second instruction block, to omit the decomposition.
Clause 11. The apparatus of clause 10, wherein the control circuitry is responsive to the identification that the second branch instruction is the final instruction of the second instruction block, when the subsequent identification identifies that the outcome of the second branch instruction has changed from taken to not-taken, to trigger a new prediction to be performed for a sequentially next instruction block subsequent to the second instruction block.
Clause 12. The apparatus of any preceding clause, comprising buffer circuitry to store, as alternative instruction addresses, instruction addresses from the first instruction block subsequent to the first branch instruction,
   wherein the control circuitry is responsive to the subsequent identification identifying a change in a first outcome of the first branch instruction:
   to flush instruction addresses subsequent to the first branch instruction from the fetch queue; and
   to identify the alternative instruction addresses in the fetch queue.
Clause 13. The apparatus of clause 12, wherein the control circuitry is responsive to the subsequent identification identifying a change in the first outcome, to trigger a new prediction to be performed for a sequentially next instruction block subsequent to the first instruction block.
Clause 14. A system comprising:
   the apparatus of any preceding clause, implemented in at least one packaged chip;
   at least one system component; and
   a board,
   wherein the at least one packaged chip and the at least one system component are assembled on the board.
Clause 15. A chip-containing product comprising the system of clause 14, wherein the system is assembled on a further board with at least one other product component.
Clause 16. A method of operating an apparatus comprising a fetch queue configured to identify a sequence of instructions to be fetched for execution, the method comprising:
   storing a plurality of prediction entries comprising a multi-taken entry, the multi-taken entry identifying:
      a first branch instruction comprised in a first instruction block and configured to divert control flow to a first target address identifying a second instruction block; and
      a second branch instruction comprised in the second instruction block and configured to divert control flow to a second target address; and
   in response to a prediction associated with the multi-taken entry and identifying an outcome of both of the first branch instruction and the second branch instruction in which the first branch instruction is predicted to be taken,
      populating the fetch queue based on the prediction; and
      in response to a subsequent identification of a change in an outcome of the second branch instruction, flushing instruction addresses subsequent to a second branch instruction address of the second branch instruction and retaining instruction addresses up to and including the second branch instruction address in the fetch queue.
Clause 17. A non-transitory computer-readable medium storing computer-readable code for fabrication of the apparatus of any of clause 1 to clause 13.

We claim:

1. An apparatus comprising:
a fetch queue configured to identify a sequence of instructions to be fetched for execution;
prediction entry storage configured to store a plurality of prediction entries comprising a multi-taken entry, the multi-taken entry identifying:
a first branch instruction comprised in a first instruction block and configured to divert control flow to a first target address identifying a second instruction block; and
a second branch instruction comprised in the second instruction block and configured to divert control flow to a second target address; and
control circuitry responsive to a prediction associated with the multi-taken entry and identifying an outcome of both of the first branch instruction and the second branch instruction in which the first branch instruction is predicted to be taken,
to populate the fetch queue based on the prediction; and
in response to a subsequent identification of a change in an outcome of the second branch instruction, to flush instruction addresses subsequent to a second branch instruction address of the second branch instruction and to retain instruction addresses up to and including the second branch instruction address in the fetch queue.

2. The apparatus of claim 1, wherein the control circuitry is configured,
to perform a decomposition of the second instruction block to generate an instruction sub-block comprising instructions of the second instruction block subsequent to the second branch instruction; and
when the subsequent identification identifies that the outcome of the second branch instruction has changed from taken to not-taken, to trigger a new prediction based on the instruction sub-block.

3. The apparatus of claim 1, wherein the control circuitry is configured, when the subsequent identification identifies that the outcome of the second branch instruction has changed from not-taken to taken, to trigger a new prediction based on a block of instructions identified by the second target address.

4. The apparatus of claim 1, wherein the subsequent identification is a subsequent prediction and the change in outcome is a change in a predicted outcome.

5. The apparatus of claim 4, wherein the subsequent prediction is performed using a higher accuracy predictor than the prediction.

6. The apparatus of claim 4, comprising further prediction circuitry configured to provide the subsequent prediction based on a global history of outcomes of branch instructions.

7. The apparatus of claim 6, wherein the further prediction circuitry is tagged geometric history length (TAGE) prediction circuitry configured to predict whether conditional branch instructions will be taken or not based on a plurality of TAGE tables tagged by a range of lengths of execution history.

8. The apparatus of claim 7, wherein the execution history is a global execution history common to all branch instructions.

9. The apparatus of claim 1, comprising prediction circuitry responsive to receipt of an instruction block identifier to perform a lookup in the prediction entry storage circuitry, wherein the prediction circuitry is responsive to a hit in the prediction entry storage circuitry to generate the prediction.

10. The apparatus of claim 2, wherein the control circuitry is responsive to an identification that the second branch instruction is a final instruction of the second instruction block, to omit the decomposition.

11. The apparatus of claim 10, wherein the control circuitry is responsive to the identification that the second branch instruction is the final instruction of the second instruction block, when the subsequent identification identifies that the outcome of the second branch instruction has changed from taken to not-taken, to trigger a new prediction to be performed for a sequentially next instruction block subsequent to the second instruction block.

12. The apparatus of claim 1, comprising buffer circuitry to store, as alternative instruction addresses, instruction addresses from the first instruction block subsequent to the first branch instruction,
wherein the control circuitry is responsive to the subsequent identification identifying a change in a first outcome of the first branch instruction:
to flush instruction addresses subsequent to the first branch instruction from the fetch queue; and
to identify the alternative instruction addresses in the fetch queue.

13. The apparatus of claim 12, wherein the control circuitry is responsive to the subsequent identification identifying a change in the first outcome, to trigger a new prediction to be performed for a sequentially next instruction block subsequent to the first instruction block.

14. A system comprising:
the apparatus of claim 1, implemented in at least one packaged chip;
at least one system component; and
a board,
wherein the at least one packaged chip and the at least one system component are assembled on the board.

15. A chip-containing product comprising the system of claim 14, wherein the system is assembled on a further board with at least one other product component.

16. A method of operating an apparatus comprising a fetch queue configured to identify a sequence of instructions to be fetched for execution, the method comprising:
storing a plurality of prediction entries comprising a multi-taken entry, the multi-taken entry identifying:
a first branch instruction comprised in a first instruction block and configured to divert control flow to a first target address identifying a second instruction block; and
a second branch instruction comprised in the second instruction block and configured to divert control flow to a second target address; and
in response to a prediction associated with the multi-taken entry and identifying an outcome of both of the first branch instruction and the second branch instruction in which the first branch instruction is predicted to be taken,
populating the fetch queue based on the prediction; and
in response to a subsequent identification of a change in an outcome of the second branch instruction, flushing instruction addresses subsequent to a second branch instruction address of the second branch instruction and retaining instruction addresses up to and including the second branch instruction address in the fetch queue.

17. A non-transitory computer-readable medium storing computer-readable code for fabrication of an apparatus comprising:
a fetch queue configured to identify a sequence of instructions to be fetched for execution;
prediction entry storage configured to store a plurality of prediction entries comprising a multi-taken entry, the multi-taken entry identifying:
a first branch instruction comprised in a first instruction block and configured to divert control flow to a first target address identifying a second instruction block; and
a second branch instruction comprised in the second instruction block and configured to divert control flow to a second target address; and
control circuitry responsive to a prediction associated with the multi-taken entry and identifying an outcome of both of the first branch instruction and the second branch instruction in which the first branch instruction is predicted to be taken,
to populate the fetch queue based on the prediction; and
in response to a subsequent identification of a change in an outcome of the second branch instruction, to flush instruction addresses subsequent to a second branch instruction address of the second branch instruction and to retain instruction addresses up to and including the second branch instruction address in the fetch queue.
